(19) United States
(12) Patent Application Publication
(10) Pub. No.: US 2002/0087339 A1
(43) Pub. Date: Jul. 4, 2002

(54) Business incentive method

(76) Inventor: Ronnie W. Pegram, Wake Forest, NC (US)

Correspondence Address: COATS & BENNETT, PLLC, P O BOX 5, RALEIGH, NC, 27602, US

(21) Appl. No.: 09/754,718

(22) Filed: Jan. 4, 2001

(51) Int. Cl. G06F 17/60

(52) U.S. Cl. 705/1; 705/35

(57) ABSTRACT

A method of promoting business comprises purchasing the legal goodwill of an individual while requiring that the individual execute a pledge and a contract. The individual is required to start a business. Alternatively, this method may be used to purchase legal goodwill of an individual in exchange for forbearance on interest or a discount to the purchase price of a good or service.

### BACKGROUND OF THE INVENTION

The present invention relates to a technique to promote economic development in a defined geographic area.

Many individuals have an entrepreneurial bent. However, a problem faced by many individuals of this mindset is the accumulation of capital necessary and sufficient to begin exploiting ideas behind their entrepreneurship.

Several techniques have been used in the past. The simplest is a loan from a lending institution such as a bank or savings and loan establishment. However, many individuals do not have the personal resources or credit history to support such loans and thus, they are denied. This situation is true even for new corporations, as many lending institutions require personal guarantees by the founders of new corporations before extending credit. Lending institutions are also subject to the vagaries of the economy with interest rates on the loans sometimes dictating whether individuals are willing to attempt to secure such a loan. Further, in times of depression or recession, lending institutions may be leery of extending credit for fear that the business is sure to fail, foreclosing an opportunity for the loan to be repaid.

Another option available to a select few is the solicitation of venture capital. This path too is fraught with disappointment. Initially, finding potential investors is problematic, even for those with good ideas. Further, there are almost no guarantees that an investor will chose a particular individual in whom to invest. This is especially true to the extent that historically the number of people seeking investment dollars outnumbers the available investment dollars.

A third option is leveraging an existing business into the new business. This only works where there is an underlying business from which to leverage. As many individuals do not have that luxury, this is not an option for many people.

Governmental entities are also a possibility. While few governmental entities realize it, new businesses are a mother lode of potential tax revenue. Small businesses pay a large percentage of business-related taxes. Further, there is a snowball effect because each new business spends money with other businesses and provides salaries to employees who in turn have money to spend in the economy. Thus, governmental entities have a strong incentive to encourage the development of new businesses. Some programs do exist that allow low interest loans to new companies, but most of these programs are directed to groups historically underrepresented in the business communities. Alternatively, these programs may be underadvertised, resulting in low disbursements.

As an aside, most if not all of these options are loans. Thus, the money must be paid back or the investors will want a return on their investment. This puts additional pressure on the entrepreneur to have quick success. This amounts to a recipe for disaster as short term cash flow problems may hinder long term solutions.

Thus, there remains a need for an effective way to provide individuals with resources sufficient to start a new business and promote economic development.

### SUMMARY OF THE INVENTION

The present invention comprises a method of providing money to individuals to start a new business, thus spurring economic development. The method comprises purchasing the tax concept of goodwill of a person and/or a new business. To determine which person's goodwill will be purchased, the service provider may initially sell business plan templates to a plurality of individuals. Each individual may also be presented with an opportunity to take a pledge or oath to promote economic development and start a new business. The service provider may collate all the individuals who have not only purchased a template, but also have taken the pledge into a pool of candidates. From this pool, the service provider may select one or more candidates from whom the goodwill will be purchased.

In an alternate embodiment, goodwill is purchased in exchange for interest payments on the purchase of a high cost item such as a network server. The seller receives the goodwill and possibly some value, while the buyer receives the item purchased. Freedom from interest payments allows the buyer to more easily afford to start or maintain a fledgling business.

Care must be taken to meet certain legal requirements relating to lotteries and gambling, however, it is believed that the exchange of goodwill for a sum of money obviates any such concerns if done properly.

### BRIEF DESCRIPTION OF THE DRAWINGS

FIG. 1 illustrates a schematic drawing of a computer network for use with the present invention;

FIG. 2 illustrates a schematic drawing of a postal network for use with the present invention;

FIG. 3 illustrates a flow chart diagram of one embodiment of the methodology of the present invention;

FIG. 4 illustrates a flow chart diagram of an alternate embodiment of the methodology of the present invention.

### DETAILED DESCRIPTION OF THE INVENTION

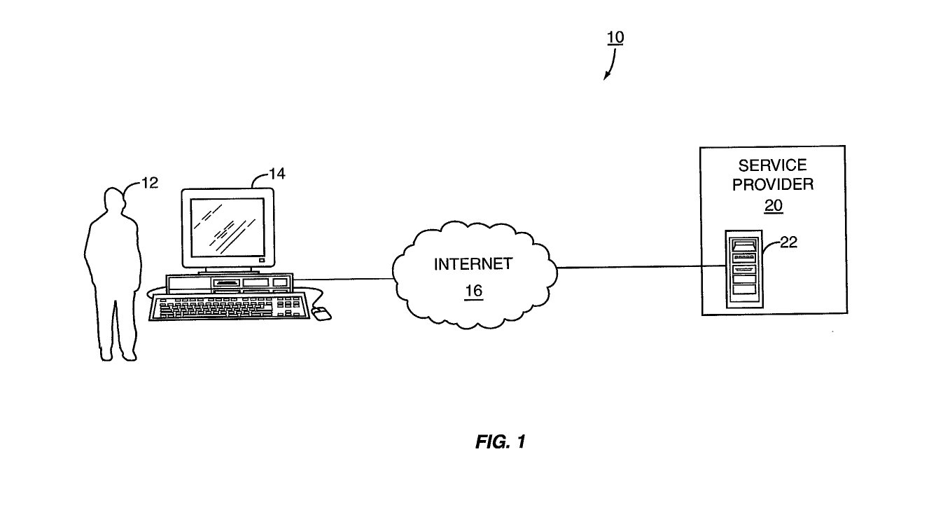

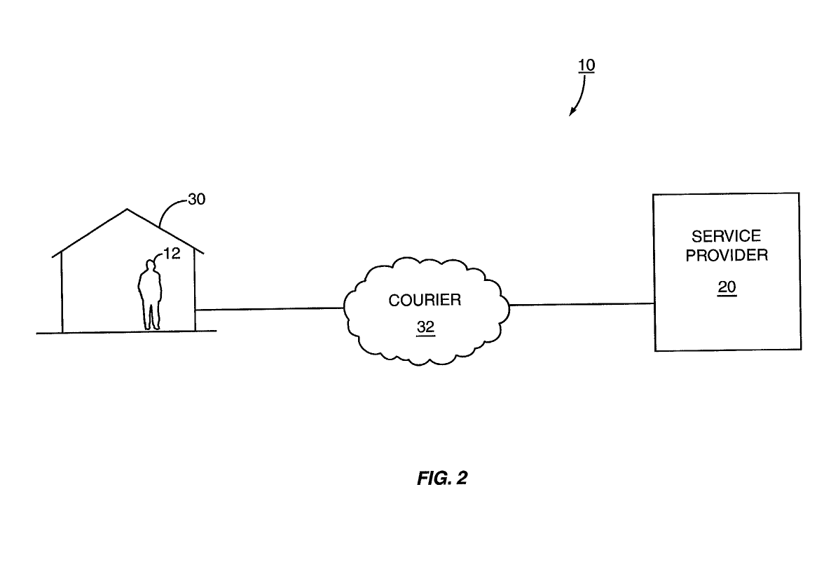

The present invention concerns a method for promoting business planning and business start-ups. This method may be implemented through a number of different physical media, however two exemplary embodiments of communication systems 10 are presented in FIGS. 1 and 2 as a background for the methodology of the present invention. Turning now to FIG. 1, a first embodiment of a communication system 10 is presented. Communication system 10, in this embodiment, comprises a user 12, a computer 14, the Internet 16, a service provider 20, and a server 22.

User 12 uses computer 14 in a conventional manner. Computer 14 may include input and output devices such as a keyboard, mouse, display, speakers, and the like. The term “computer” as used herein is meant to be construed broadly to include any data processing structure capable of performing the functions recited herein. This functionality may be achieved through a general-purpose computer programmed through software or a special purpose computer hardwired as needed or desired. Thus, laptops, mobile phones, personal digital assistants, and the like are meant to be included in the term. Computer 14 may be connected to the Internet 16 through a landline, cable modem, DSL modem, wireless modem, or the like as needed or desired. Access to the Internet 16 may be achieved through an Internet Service Provider (ISP) or directly as needed or desired. Internet 16 may be navigated through any appropriate tool such as a web browser like Internet Explorer™, Netscape Navigator™ or the like.

Service provider 20 may be a corporate entity, an individual, or other legal entity responsible for providing the service of the present invention. In this embodiment, service provider 20 may use a server 22 connected to the Internet 16 to host a web site accessible from the Internet 16. Server 22 may have the appropriate uninterruptible power supply, firewalls, and the like, as are well understood in the industry to insure continuous secure operation. Further, back-ups may be made as needed to correct catastrophic failures.

User 12 may access the web site of the service provider 20 through appropriate conventional means, such as typing a Uniform Resource Locator (URL) in the web browser. Once at the web site, the user 12 may operate within the methodology of the present invention as explained below.

A second embodiment of communication system 10 relies on courier services such as the United States Postal Service, Federal Express™, and the like as illustrated in FIG. 2. In this embodiment, communication system 10 comprises a user 12, a residence 30, a courier service 32, and service provider 20. Residence 30 may be someone's abode or equivalently their place of business so long as they are capable of receiving mail there. User 12 may communicate through the courier service 32 with the service provider 20. Exemplary courier services 32 comprise FEDERAL EXPRESS, UPS, USPS, AIRBORNE EXPRESS, and the like. These conventional systems and their use are well understood.

It should be appreciated that other communication systems may also be used. For example, telephone lines may be used with the purchases provided thereover. In such a system, the user 12 may recite a credit card number over the phone to make the purchases of the present invention's methodology. A recording of the user's 12 voice may be made to verify that they in fact made the pledge as explained below. Other systems are also possible.

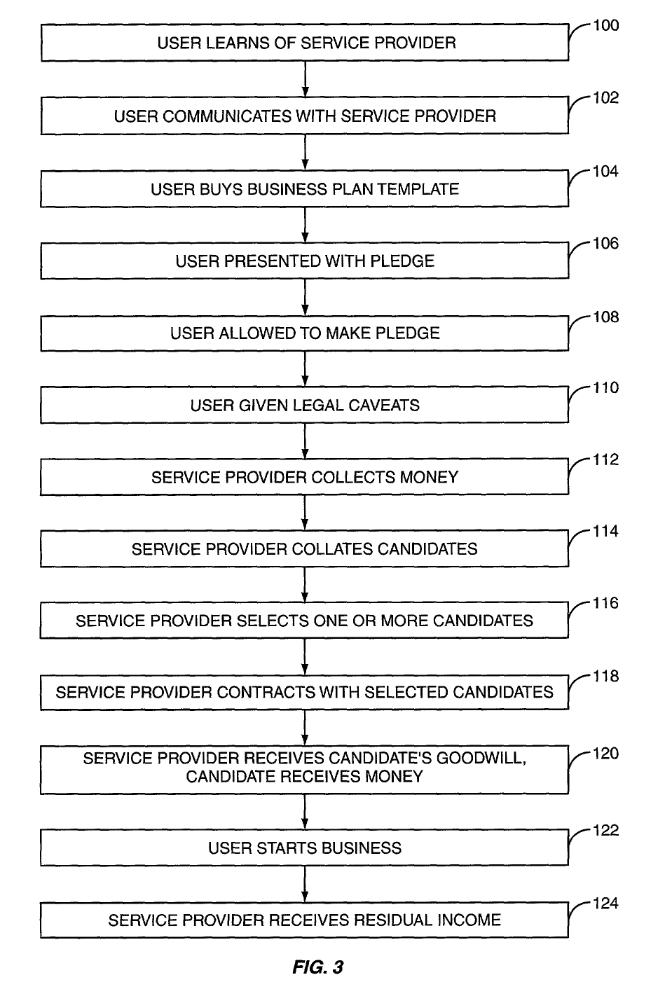

Against the backdrop of such communication systems 10, the methodology of the present invention may now be explored with reference to FIG. 3. A user 12, within a predetermined geographic area initially learns of the service provider 20 (block 100). The predetermined geographic area in an exemplary embodiment is the U.S. and its territories. The predetermined geographic area may be implemented to promote business in a particular area for patriotic, legal, or other reasons. User 12 may learn of the service provider 20 by a print advertisement, a radio or television advertisement, a link on another web page, word of mouth recommendation, or the like. User 12 then communicates with the service provider 20 through a communication system 10 (block 102).

The communication between the user 12 and the service provider 20 comprises the user 12 buying a business plan template (block 104). The business plan template may be a template on which people may make coherent, organized business plans. An exemplary template may include probing questions such as “what are you going to sell;” “how are you going to sell it;” “who will your competitors be;” and the like. By answering these questions or similar ones, the person using the template is well on their way to having a coherent business plan. Alternatively, some other document, good, or service may be purchased from the service provider 20. User 12 is also presented with a pledge (block 106). This pledge may state that the user 12 desires to create, form, and then offer his goodwill for sale, has a desire to start a new business within the predetermined geographic area, and will make a bona fide effort to start such a business if his goodwill is purchased. In an exemplary embodiment, the pledge might require the user 12 to create a business in the United States. User 12 is presented with the opportunity to make the pledge (block 108). Concurrently with the opportunity to make the pledge, or perhaps earlier, as needed or desired, the user 12 is also presented with an opportunity to preview a contract that may be established between the service provider 20 and the user 12. The contract is explicated in greater detail below.

User 12 is also presented with any appropriate legal caveats (block 110). These may be required to insure the legality of the present methodology. Exemplary caveats include statements that this is not a lottery; user is creating and forming goodwill and then making an offer uncoerced by the service provider; void where prohibited; and the like.

Service provider 20 collects money from user 12 (block 112). This maybe accomplished by accepting credit card information and charging a credit card, receiving a check, receiving bank account information, or the like. Where the information is provided over the Internet 16, appropriate encryption or otherwise secure transmission techniques may be used to prevent unauthorized access to the information.

Service provider 20 then collates candidates that have not only purchased the business plan template, but also agreed to the pledge (block 114). Users 12 who have not agreed to the pledge are not allowed to proceed with the further steps, although they are free to use the business plan template as they see fit. To perform this collation, at the time of payment, the service provider 20 may receive identifying information such as name, address, telephone number, and the like. In an exemplary embodiment, this collation occurs periodically after a predetermined amount of time, for example, once a week. Other time frames are also possible if needed or desired, and need not be periodic.

From the collated candidates, the service provider 20 selects one or more candidates that will potentially receive money from the service provider 20 (block 1 16) as part of a contract to be formed as explained below. This may be done on some objective criteria or some subjective criteria. However, care must be taken that the process is not completely random as that may conflict with gambling or lottery laws in place in some jurisdictions.

Service provider 20 then contracts with the selected candidates (block 118). This is the contract that the user 12 was able to see prior to making the pledge. The contract states that the service provider 20 will receive the candidate's goodwill, as that term is understood by the Internal Revenue Service (IRS), and the candidate receives money from the service provider 20 (block 120). While goodwill is not explicitly defined in any statute or tax regulation, it has long been recognized by the IRS. The Supreme Court has provided several definitions in Newark Morning Ledger Co. v. United States, 507 U.S. 546 (1993) in recognition of this fact. This case, and its accompanying definitions, is hereby incorporated by reference in its entirety. Alternatively, the goodwill of the nascent business may be purchased instead. As yet another alternative, the goodwill of both the candidate and the nascent business may be purchased. In one embodiment, the money with which the service provider 20 buys the goodwill comes from the revenue generated by the sale of business plan templates. In an exemplary embodiment, the service provider 20 may guarantee that it will spend half of the revenue generated from the sale of business plan templates. Service provider 20 may even have some published schedule reflecting how much will be paid out to how many candidates based on revenues received within the predetermined amount of time. In an exemplary embodiment, if the service provider 20 received one million dollars of revenue from sales, it might purchase the goodwill from two candidates, each at two hundred twenty-five thousand dollars. If five million dollars of revenue were generated, one candidate may receive one million dollars, and four additional candidates receive three hundred seventy-five thousand dollars each. These purchase prices are intended to be exemplary and not limiting. As long as the schedule is disclosed prior to the purchases, and the customers are fully apprised of the terms and conditions under which they are offering the goodwill for sale, it is expected that this will not raise any legal issues such as fraud or gambling.

User 12 then uses the income received from the sale of the goodwill to start a new business within the predetermined geographical area (block 122). This may be any legal business within the predetermined geographical area. Products made outside the predetermined geographical area may be imported and sold therewithin if desired, or products made within the geographical area may be exported for sale. The goal is that a business actually occurs within the predetermined geographical area, thus achieving the promotion of business within the predetermined geographical area. The contract may include revocation provisions in the event that a new business is not started within a reasonable amount of time, but such is not strictly required by the present invention. Thus, if, for example, the individual who has sold the goodwill does not start a new business within sixty days of the sale of the goodwill, as shown by some contemporaneous evidence such as a business license, the individual is required to return the money to the service provider 20.

As a further part of the contract, the service provider 20 may further receive a revenue stream from the individual who sold the goodwill (block 124). In an exemplary embodiment, this revenue stream may be one quarter of one percent of profits for a five-year period from the time of sale. Other amounts and timeframes are also contemplated.

While presented as a linear process, the order of the steps need not occur precisely as indicated. Some steps logically occur before others, but given the non-linearity of human decision making, it should be appreciated that variations in the order are contemplated as needed or desired.

To facilitate execution of the contract, the service provider 20 may pay for the candidates to fly to the service provider 20. Further, notarized, executed copies of the contract, the pledge, and any other documentation required may be kept by the service provider 20. Still further, the service provider 20 may require a completed business plan from the candidate, a copy of the business license, a taxpayer identification number, and the like prior to disbursement of the money. Additionally, the service provider 20 may withhold income taxes or other governmental levies on the income to the candidate to comply with appropriate government statutes, rules and/or regulations.

While not germane to the present invention, the legality of the present invention is assisted by the cooperation of the pledge, the contract, and the candidates' creation, formation, and offer of goodwill. Only candidates that have executed the pledge, and have bought a business plan template (or equivalent commodity as previously discussed) are considered to have their goodwill purchased. The contract, freely entered into by a consenting adult, requires them to make a good faith effort to start a new business to keep the money. If the business fails, the money is not returned to the service provider; however, if no effort is made to start a business, then the contract may cause a forfeiture of the money as previously discussed. To promote business within the predetermined geographical area, the contract may require that the business be a legal business within the predetermined geographical area.

While multiple communication systems 10 are contemplated, it is expected that this will primarily be implemented through a web page on the Internet 16 as disclosed with respect to FIG. 1. Such a web page may have an exemplary structure as follows.

An initial page may comprise a splash page, full of catchy slogans, graphics, or the like, as well as a touch of information to keep the attention of the casual browser. The web page may in fact be a plurality of web pages displayed concurrently, in effect being divided into one or more active and one or more passive or static fields. A plurality of links may be provided on the splash page, including a help link, a “News” link, an “Inside Info” link, a “Pledge” link, as well as others.

In one embodiment, the service provider 20 may provide consultation services or other products, as well as selling the business plan templates discussed above. The help link may take a user 12 to a page that describes the nature of the consultation services, relevant products, and fee structures.

The “News” link may take the user 12 to a promotional page that sets forth any additional agenda that the service provider 20 may have. This may include responses to political attacks, encouragements to users to voice their support of the service provider 20 in the face of politically motivated attacks or the like. Further, this page may include information on job openings within the service provider 20 or remote office possibilities if needed or desired.

The “Inside Info” link may take the user to a page that describes the pledge and requirements thereof as well as why the business plan template may be useful. This may be used as an additional sales tool.

Another link may take the user to a page announcing new businesses formed by the candidates from whom the goodwill has been purchased. As it is expected that purchases may be made weekly, this page will be periodically updated with the new purchases. In effect, this page gives free advertising to the new businesses created by the present method.

Still another link may take the user to a list of the candidates most recently selected to have their goodwill purchased. This may act as a notification page so that candidates may look at this page to determine if their pledge and purchase of a business plan was accepted by the service provider 20 and that they are going to sell their goodwill to the service provider 20. This page may optionally list the amount for which the goodwill was purchased.

Another link may act as a sign up link. This may provide an initial screen that details the security mechanisms in place by the service provider 20 to protect credit card information and identifying information from the candidates. Another link from this page may take the user to a sign in screen that collects the needed identifying information as well as payment information. This screen may be a pop up screen or a new page entirely as needed or desired. One or the other screen may explain that there is no limit on the number of purchases of business plan templates. Further the second screen may inquire as to whether the user 12 wishes to make just a purchase of a business plan template or whether the user 12 also wishes to commit to the pledge so as to become a candidate from whom the goodwill may be purchased. Upon completion of the desired information, the business plan template is then accessible to the user 12. This may be downloaded to the user's computer 14 in any appropriate format such as MSWORD, .txt, a rich text format, or the like. This may be emailed to the user 12, mailed to the user 12 through a courier service 32, faxed to the user 12, or the like as needed or desired. In the event that the user 12 loses his copy, this screen may be accessible by password or other device so that the user 12 may secure another copy if needed or desired.

Another link from the splash page may take the user 12 to a page that is a combination advertisement and explanation of how the methodology works. It may further state that having had the goodwill of one business purchased does not preclude a user 12 from purchasing a business plan template and making another pledge in another predetermined time block (e.g., the week after they had their goodwill purchased the first time) as long as they can start two new businesses (one for each pledge). Further, multiple template purchases and pledges in the same block of time may result in two purchases made from the same candidate in the same week.

Still another link may take the user 12 to a page that described the economic snowball effect of the present invention as well as continue the barrage of promotional verbiage that may help persuade a user 12 to make a purchase and a pledge.

Yet another link may take the user 12 to a page that describes the formalities required to collect the money with which the goodwill is purchased. Such formalities may include appropriate identification, the appropriate documentation as to the pledge, the contract, and the like.

Another link may take the user 12 to a page that describes what the service provider 20 is doing with the rest of the money collected from the sales of business plan templates and a general description of any planned expansion by the service provider 20. It may describe how the service provider 20 is promoting economic development if needed or desired.

Still another link takes the user 12 to a page that describes the process after plan purchase and pledge submission. This page may be more informational than promotional, but need not be. It may further alert the user 12 to consequences for failure to start a business within a certain amount of time, as well as alert people to prosecutions for fraud on the service provider 20 and the like.

Yet another link may take the user to a copy of the pledge. This may be a summary of the pledge or a verbatim copy of the pledge as needed or desired. This is provided so that the user 12 may make an informed decision as to whether they desire to make the pledge. To assist in later contract enforcement, the user 12 must have had the opportunity to be apprised fully of the terms of the contract in which he is about to enter. To this end, the web page may be structured so that the user 12 has to declare affirmatively that he has read and understood the terms of the pledge and contract and that he enters into them voluntarily. This may be performed much like the acceptance of software licenses or comparable situations. Likewise, the user 12 may have the opportunity to stop the process if so desired.

Another link may take the user 12 to a schedule that details how many purchases of goodwill will be made based on income to the service provider 20. Likewise, this schedule may indicate at what rates the purchases will be made.

Other pages such as a legal notices, a full disclosure of legal obligations of all parties, press releases, advertising solicitation, and the like may also be linked to the web page.

Additionally, the web page may be structured so that is viewable by any browser on any of the three major platforms (Windows, Mac, Unix). This may be accomplished at least in part by supporting Verdana, Arial, and Helvetica fonts. Still further, the links may be positioned on the right hand side of the screen where some studies suggest people are more inclined to look for command links. As a further feature, the web pages are designed to fit automatically to the display size of the user 12. In one embodiment, the web pages are designed to fit properly on any display between nine and forty inches. This may eliminate the need for some scroll bars and other cumbersome navigation aids, although such are not outside the scope of the present invention.

It should be appreciated that most of these pages are interrelated by links in the static fields so that the user 12 may access whatever information desired from almost any page by appropriate selection of a link. Further, other pages may be implemented if needed or desired. Likewise, pages may be combined, parsed, or otherwise manipulated if needed or desired. The preceding discussion was by way of example, and not intended to be limiting.

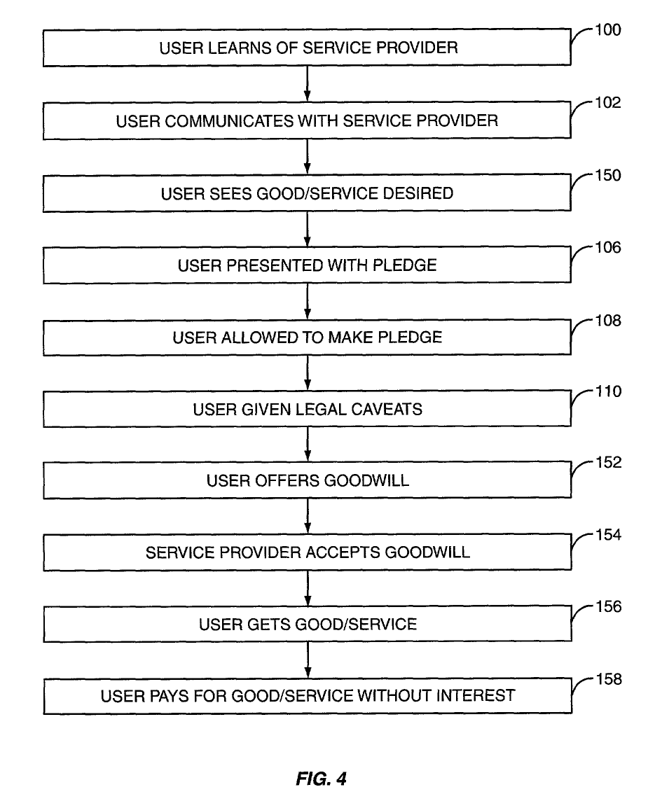

An alternate embodiment is illustrated in FIG. 4. This alternate embodiment relies on much of the same methodology, but rather than purchase the goodwill with money, the goodwill is purchased in exchange for forbearance of interest payments on an item that the user 12 desires to purchase. Note that the IRS views forbearance of interest payments to be income to the individual who does not have to pay the interest. The present invention likewise defines this forbearance as income.

Many of the steps of this alternate method are the same, but are set forth in FIG. 4, for completeness. User 12 learns of the service provider 20 (block 100) and communicates with the service provider 20 (block 102) as previously explained. On the web page, or through other communication medium the user 12 learns of or sees certain goods and/or services that the service provider 20 may provide (block 150). User 12 is further presented with the pledge (block 106). Again, concurrently, the user 12 may likewise be presented with the contract terns so that they are fully apprised of the ramifications of their actions. User 12 is allowed to make the pledge (block 108). User 12 is further given the appropriate legal caveats (block 110).

User 12 then creates, forms, and offers to sell to the service provider 20 goodwill (block 152). This may be his or her own goodwill, or the goodwill of a nascent business for which the good or service is being purchased. Coupled with the pledge, the service provider 20 may now accept the goodwill (block 154). User 12 gets the desired good or service (block 156). User 12 pays for the good or service without interest (block 158) and may use it the good or service for the fledgling business. As a variation on this, the goodwill may have a value greater than the value of the interest forborne. In such an instance, the price of the good or service may be discounted by some amount if needed or desired.

Again, while presented as a linear process, the method of the alternate embodiment may be carried out in other orders. Specifically, the legal caveats and the opportunity to view to the contract may be presented prior to making the pledge so that the user 12 is making an informed decision when making the pledge.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of promoting business comprising:
purchasing goodwill from a candidate thereby providing income for use in developing a business.

2. The method of claim 1 further comprising selling a business plan template to the candidate.

3. The method of claim 1 wherein the step of purchasing goodwill from the candidate is conditioned upon the candidate executing a pledge.

4. The method of claim 3 wherein the pledge declares that the candidate will make a bona fide effort to start a business.

5. The method of claim 1 further comprising selling a plurality of business plan templates to a plurality of individuals.

6. The method of claim 5 further comprising selecting from said plurality of individuals to whom business plan templates were sold one or more candidates from whom the goodwill will be purchased.

7. The method of claim 6 further comprising requiring individuals to execute a pledge prior to purchasing the goodwill therefrom.

8. The method of claim 1 further comprising conditioning the step of purchasing upon execution of a contract between the candidate and an entity performing the purchasing.

9. The method of claim 8 wherein conditioning the step of purchasing upon execution of a contract comprises conditioning the step of purchasing upon execution of a contract requiring a revenue stream to be paid to the entity performing the purchasing.

10. The method of claim 9 wherein said revenue stream has a five-year term.

11. The method of claim 5 wherein selling a plurality of business plan templates to a plurality of individuals comprises selling said business plan templates over the Internet.

12. The method of claim 5 wherein selling a plurality of business plan templates to a plurality of individuals comprises selling said business plan templates through the mail.

13. The method of claim 1 wherein purchasing goodwill from a candidate comprises purchasing goodwill with a check.

14. The method of claim 1 wherein purchasing goodwill from a candidate comprises withholding income tax incurred by said income.

15. The method of claim 1 wherein purchasing goodwill from a candidate thereby providing income for use in developing a business comprises purchasing from a candidate from a predetermined geographic area.

16. The method of claim 15 further comprising conditioning the step of purchasing goodwill on the candidate starting a business within said predetermined geographic area.

17. A method of promoting business within a predetermined geographical area, comprising:
selling business plan templates to individuals for a predetermined amount of time;
offering the individuals an opportunity to make a pledge to promote business within the predetermined geographical area;
collecting identifying information about individuals that have bought a business plan template and made the pledge thereby forming a pool of candidates;
selecting one or more candidates from said pool; and
purchasing goodwill from said one or more candidates from said pool thereby providing income for use in developing a business.

18. The method of claim 17 further comprising conditioning the step of purchasing goodwill upon execution of a contract.

19. The method of claim 18 wherein conditioning the step of purchasing goodwill upon execution of a contract comprises executing a contract obligating the candidate to start a business within the predetermined geographic area.

20. The method of claim 18 wherein conditioning the step of purchasing goodwill upon execution of a contract comprises executing a contract obligating the candidate to pay a revenue stream to the purchaser.

21. The method of claim 17 further comprising using at least a portion of revenue from the sale of business plan templates to fund the purchasing of the goodwill.

22. A method of promoting business comprising:
purchasing goodwill from an individual's nascent business thereby providing income for use in developing the business.

23. A method of starting a business, comprising:
purchasing a business plan template from a service provider;
making a pledge to the service provider to make a bona fide effort to start a business;
entering into a pool of candidates who have likewise purchased business plan templates and made the pledge;
being selected from said pool of candidates; and
contracting with the service provider to receive a sum of money in exchange for the goodwill of the business.

24. A method of helping entities start a business, comprising:
selling a good or service;
receiving pledges from entities that have purchased the good or service and are willing to contract to have the possibility for the entities to receive start up money to start the business;
selecting at least one of the entities to receive the start up money;
contracting with the at least one of the entities such that the at least one of the entities receives start up money; and
receiving goodwill from the entity.
